(19) United States
(12) Patent Application Publication
(10) Pub. No.: US 2007/0230469 A1
(43) Pub. Date: Oct. 4, 2007

(54) Transmission apparatus

(75) Inventor: Kazuhiro Teshima, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/488,569

(22) Filed: Jul. 18, 2006

(30) Foreign Application Priority Data
Mar. 28, 2006 (JP) 2006-087429

(51) Int. Cl. H04L 12/56; H04L 12/28

(52) U.S. Cl. 370/392; 370/420

(57) ABSTRACT

A disclosed searching unit searches learning tables corresponding to ports other than a first port that receives a first packet using a source address and a destination address of the first packet whose source address and destination address are not registered in a first learning table corresponding to the first port. A transferring unit transfers contents of a second learning table, corresponding to a second port, to the first learning table, in response to the searching unit finding that the source address and the destination address of the first packet are registered in the second learning table. A port from which the first packet is to be sent out is determined based on the contents transferred to the first learning table.

### BACKGROUND OF THE INVENTION

1. Field of the Invention

The present invention relates generally to transmission apparatuses, and more particularly to a transmission apparatus equipped for searching a learning table using an address of a received packet to determine the port from which to send out the packet.

2. Description of the Related Art

In recent years and continuing, structures of networks and transmission apparatuses included in networks are becoming increasingly complex. Accordingly, the system builder or the supervisor of a network needs to be skilled to a certain degree. If the person in charge of the network makes an error in the construction or the setup of the network, a failure may occur in a transmission apparatus, causing a packet to be received at an unintended port.

Furthermore, a malicious user may deliberately launch a MAC scan attack to input packets to multiple ports by continuously changing the source MAC address. Such invalid packets are unwanted by carriers, and should be discarded, as they may have a negative impact on an existing network. In some instances, the port for receiving a certain packet may be purposely changed due to construction work conducted at a higher level of the network, and the packet is to be transmitted according to the change. Thus, it is sometimes necessary to select either to discard or to transmit a packet.

FIG. 1 is a diagram for describing a learning method performed by a conventional transmission apparatus 10. The transmission apparatus 10 has a layer 2 switch function. It is assumed that the transmission apparatus 10 has already learned (registered) that a packet having a destination MAC address DA1 and a source MAC address SA1 is to be input to a port P2 and output from a port P4.

When the packet having the destination MAC address DA1 and the source MAC address SA1 is input to a port P1 of the transmission apparatus 10, learning tables at the ports P2 and P4 are cleared, and then registration is performed once again. Specifically, a copy unit 11 creates copies of the packet having the destination MAC address DA1 and the source MAC address SA1, and flooding is performed by multicasting the copies from the ports P2, P3, and P4. Accordingly, the source MAC address SA1 and the port P1 are registered in association with each other in each of the learning tables at the ports P1 through P4.

In a technology disclosed in Japanese Laid-Open Patent Application No. 2004-320248, when a source MAC address has already been registered when a learning correction frame is received, and the formerly registered port is different, the receiving port is registered once again, and the learning correction frame is sent to the port according to the formerly registered information.

In the learning method conducted by the conventional transmission apparatus, when packets having a common source MAC address are received at different ports due to a network failure, malfunction of an opposing apparatus, or an abnormality in the MAC address, etc., flooding is repeatedly performed at the ports that have received the packets. Accordingly, the bandwidth of the operating network is reduced so that sufficient bandwidth cannot be ensured, which may lead to packet loss.

Furthermore, a malicious user may deliberately launch a MAC scan attack to input packets to multiple physical ports by continuously changing the source MAC address. Flooding is also repeatedly performed in this case, resulting in reduction of available bandwidth of the operating network. Moreover, if the learning operation is continuously performed, the MAC table may overflow. Consequently, normal operation of the transmission apparatus cannot be ensured.

### SUMMARY OF THE INVENTION

Accordingly, the present invention may provide a transmission apparatus in which the above-described disadvantage is eliminated.

A preferred embodiment of the present invention provides a transmission apparatus capable of reducing flooding operations and preventing reduction in available bandwidth of an operating network.

An embodiment of the present invention provides a transmission apparatus equipped for determining a port from which a received packet is to be sent out among a plurality of ports by searching learning tables each corresponding to one of the ports, including a searching unit configured to search the learning tables corresponding to the ports, other than a first port that has received a first packet, using a source address and a destination address of the first packet whose source address and destination address are not registered in a first learning table corresponding to the first port; and a transferring unit configured to transfer contents of a second learning table, corresponding to a second port, to the first learning table, in response to the searching unit finding that the source address and the destination address of the first packet are registered in the second learning table; wherein a port from which the first packet is to be sent out is determined based on the contents transferred to the first learning table.

An embodiment of the present invention provides transmission apparatus for determining a port from which a received packet is to be sent out among a plurality of ports by searching learning tables each corresponding to one of the ports, including a searching unit configured to search, in response to receipt of a packet by any given port, a learning table corresponding to the given port using a source address of the packet received by the given port; a counting unit configured to count a number of non-registered packets whose source addresses are found by the searching unit to be not registered in the corresponding learning table; a buffer unit configured to store the packets counted by the counting unit; and a discarding unit configured to discard from the buffer unit the non-registered packets in response to the counted number reaching a predetermined limit without receiving, during the counting of the number, any packet registered in any one of the learning tables.

According to one embodiment of the present invention, it is possible to reduce flooding operations, and hence prevent reduction of the available bandwidth of an operating network.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram for describing a learning method performed by a conventional transmission apparatus;

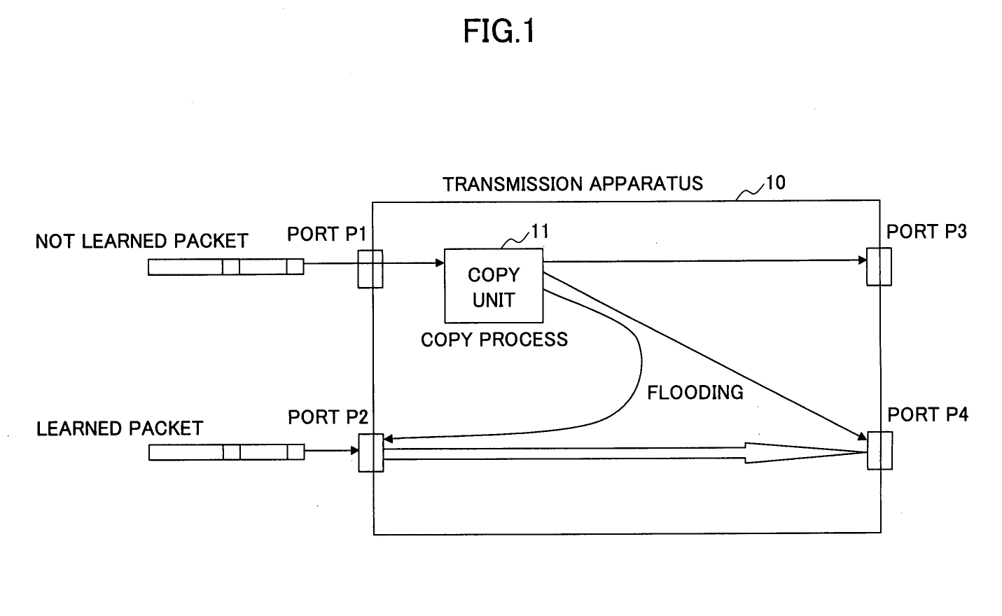

FIG. 2 is a block diagram of an embodiment of a transmission apparatus according to the present invention;

FIG. 3 is an example of a learning table;

FIG. 4 is a flowchart according to a first embodiment of the present invention; and

FIG. 5 is a flowchart according to a second embodiment of the present invention.

### DETAILED DESCRIPTION OF THE PREFERRED EMBODIMENTS

A description is given, with reference to the accompanying drawings, of an embodiment of the present invention.

<Structure of Transmission Apparatus>

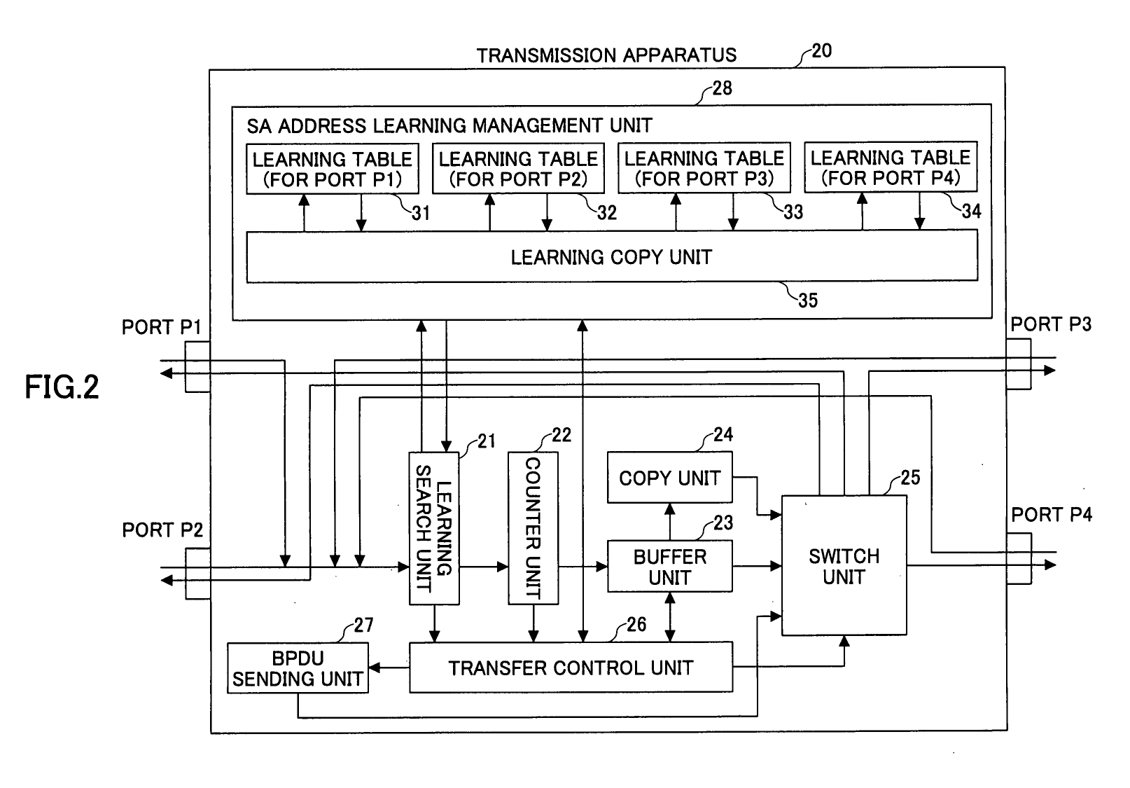

FIG. 2 is a diagram of an embodiment of a transmission apparatus 20 according to the present invention. The transmission apparatus 20 has a layer 2 switch function, and includes physical ports P1 through P4, a learning search unit 21, a counter unit 22, a buffer unit 23, a copy unit 24, a switch unit 25, a transfer control unit 26, a BPDU sending unit 27, and an SA address learning management unit 28. The SA address learning management unit 28 includes learning tables 31 through 34 corresponding to the ports P1 through P4, respectively, and a learning copy unit 35.

Packets input to each of the ports P1 through P4 are supplied to the learning search unit 21. The learning search unit 21 uses a source MAC address and a destination MAC address of each packet input for searching the learning tables 31 through 34 in the SA address learning management unit 28. Determination results of the search are supplied to the transfer control unit 26.

The counter unit 22 is activated by the transfer control unit 26, and counts the number of packets that are learned (registered) only at other ports. Specifically, a source MAC address and a destination MAC address of a packet may not be registered, i.e. not learned, in the port that receives the packet (for example, port P1), but the source MAC address and the destination MAC address of the packet may be registered, i.e. learned, in other ports (for example, ports P2, P3, P4). The counter unit 22 counts the number of such packets (hereinafter, “number of packets learned at other ports”). Further, a source MAC address of a packet may not be registered in the port that receives the packet. The counter unit 22 also counts the number of such packets (hereinafter, “number of not registered packets”). The counter unit 22 supplies the number of packets learned at other ports and the number of not registered packets to the transfer control unit 26.

The received packets are supplied to the buffer unit 23 via the counter unit 22, and accumulated in the buffer unit 23. The transfer control unit 26 causes the buffer unit 23 to read the accumulated packets, and to supply the packets to the copy unit 24 or the switch unit 25. The copy unit 24 creates copies of the packet corresponding to the number of ports from which the packet is to be output, in order to perform flooding. The copy unit 24 sends the copies of the packet to the switch unit 25.

The transfer control unit 26 causes the BPDU sending unit 27 to generate BPDU (Bridge Protocol Data Unit: control packets for RSTP) packets, and to supply the BPDU packets to the switch unit 25. The switch unit 25 performs a switching operation on the packets supplied from the copy unit 24 or the buffer unit 23, or the BPDU packets supplied from the BPDU sending unit 27, and sends these out from one of the ports P1 through P4.

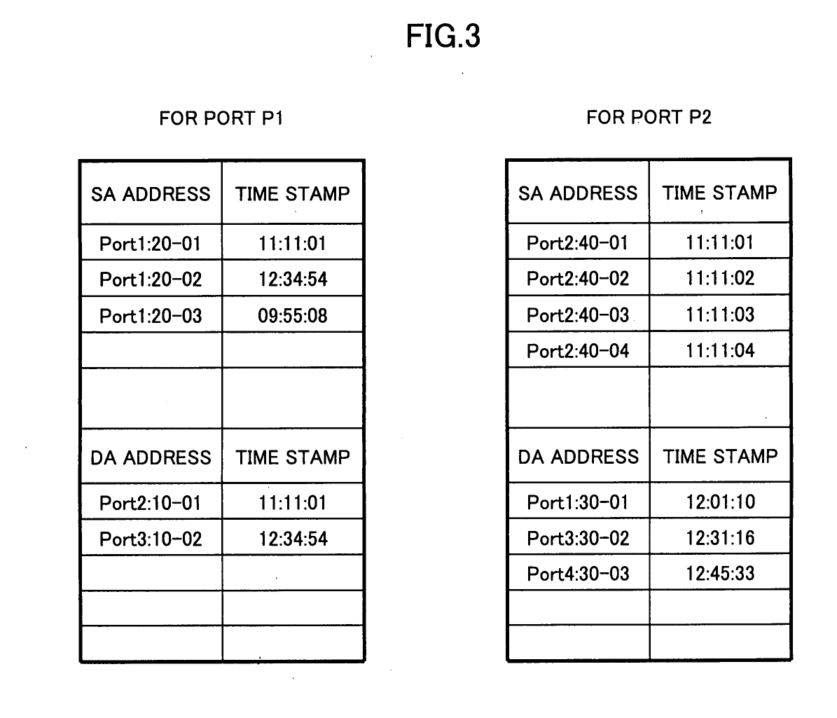

As shown in FIG. 3, information corresponding to the ports P1 through P4 is registered in the learning tables 31 through 34, respectively, in the SA address learning management unit 28. Specifically, a learned input port, a source MAC address, and a time stamp are registered in association with each other; and an output port, a destination MAC address, and a time stamp are registered in association with each other. A time stamp represents the most recent time that a source MAC address or a destination MAC address has been registered or searched for. When a packet is first input, the input port and the source MAC address are registered. When the learning operation is completed, the output port and the destination MAC address are registered.

The transfer control unit 26 causes the learning copy unit 35 in the SA address learning management unit 28 to provide a copy of the contents of a learning table in which a source MAC address is registered (for example, learning table 34), to a learning table in which the source MAC address is not registered (for example, learning table 31).

### FIRST EMBODIMENT

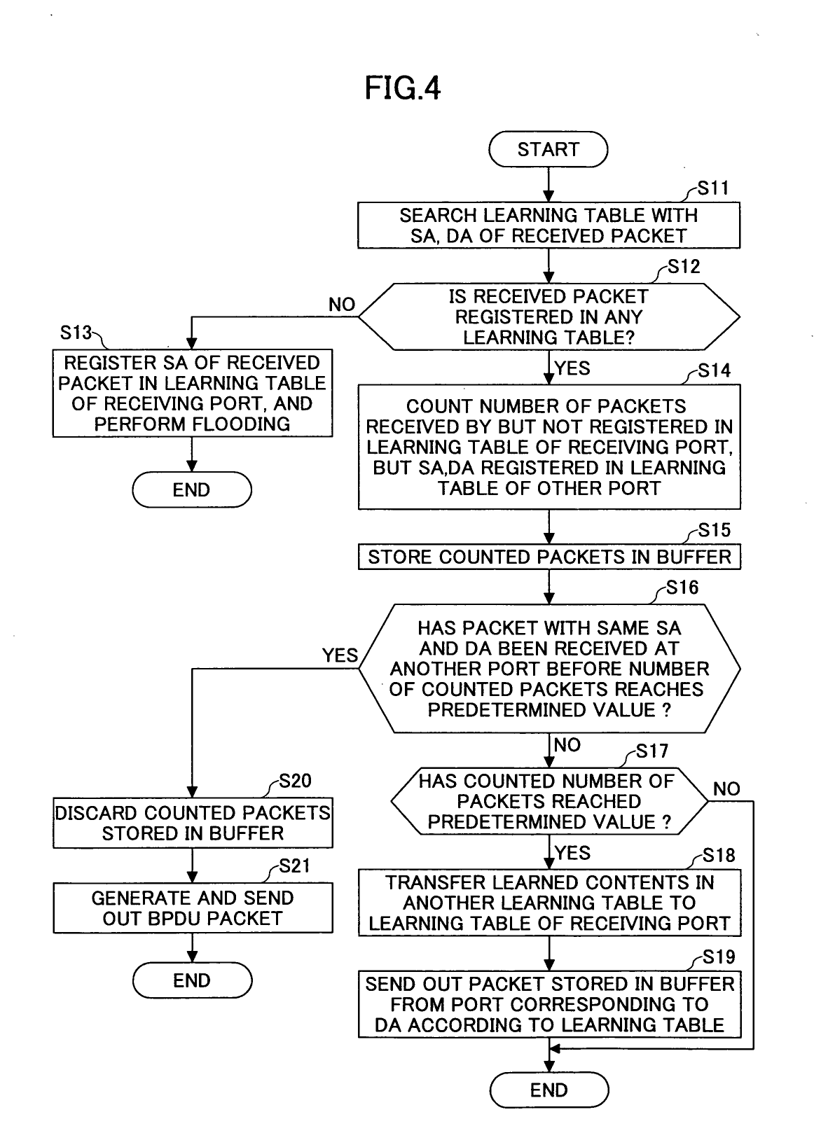

FIG. 4 is a flowchart according to a first embodiment of the present invention. In step S11 in FIG. 4, the learning search unit 21 searches a learning table (for example, the learning table 31 for the port P1) corresponding to the port (for example, the port P1; hereinafter, “subject port”) that has received a packet (hereinafter, “subject packet”), using the source MAC address (SA) and the destination MAC address (DA) of the subject packet for the search. When the source MAC address and the destination MAC address of the subject packet is not registered in the learning table corresponding to the subject port, the learning search unit 21 searches other learning tables (in this example, the learning tables 32 through 34) using the source MAC address and the destination MAC address of the subject packet, and supplies the search results to the transfer control unit 26.

In step S12, the transfer control unit 26 determines whether the source MAC address of the subject packet is registered in any of the learning tables 31 through 34. When the source MAC address of the subject packet is not registered in any of the learning tables 31 through 34 (No in step S12), in step S13, the transfer control unit 26 registers the source MAC address of the subject packet in the learning table corresponding to the subject port (in this example, the learning table 31), and performs flooding. Specifically, the transfer control unit 26 causes the copy unit 24 to create copies of the subject packet corresponding to the number of output ports (in this example, three ports), and outputs the copies from the ports P2 through P4 via the switch unit 25.

On the other hand, when the source MAC address and the destination MAC address of the subject packet are not registered in the learning table corresponding to the subject port, but are registered in any of the learning tables 31 through 34 (Yes in step S12), in step S14, the transfer control unit 26 causes the counter unit 22 to count the number of packets that have the same source MAC address and destination MAC address as the subject packet, and that have been received by the subject port (in this example, the port P1) (number of packets not registered at subject port but registered at other ports)

In step S13, the transfer control unit 26 stores the counted packets in the buffer unit 23.

In step S16, the transfer control unit 26 determines whether a packet having the same source MAC address and destination MAC address as the subject packet has been received at a port (in this example, any of the ports P2, P3, and P4) other than the subject port (in this example, the port P1) that has received the subject packet, before the number of packets counted by the counter unit 22 (number of packets not registered at subject port but registered at other ports) reaches a predetermined value (for example, 100). The transfer control unit 26 makes this determination based on whether time stamps associated with source MAC addresses and destination MAC addresses in the learning tables 32 through 34 corresponding to the ports P2 through P4 have been updated.

When such a packet has not been received at a port other than the subject port before the counted number reaches the predetermined value (No in step S16), the transfer control unit 26 determines that the addresses have been normally switched in the network. Accordingly, in step S17, the transfer control unit 26 determines whether the number of packets counted by the counter unit 22 (number of packets not registered at subject port but registered at other ports) has reached the predetermined value. When the counted number has reached the predetermined value (Yes in step S17), in step S18, the transfer control unit 26 causes the learning copy unit 35 to transfer contents registered in another learning table (in this example, one of the learning tables 32 through 34) that has registered the source MAC address and the destination MAC address of the subject packet (hereinafter, “registered contents”), to the learning table corresponding to the subject port that has received the subject packet (in this case, the learning table 31). Specifically, the registered contents include the learned output port, the destination MAC address, and the associated time stamp. After the transfer operation, the registered contents are discarded from the transfer source learning table.

In step S19, the transfer control unit 26 reads the packets stored in the buffer unit 23 having the same source MAC address and destination MAC address as the subject packet, and causes the switch unit 25 to perform the switching operation on the read packet based on the learning table corresponding to the subject port that has received the subject packet (in this example, the learning table 31), and to send the read packet out from the port corresponding to the destination MAC address, according to the registered contents transferred to the learning table of the subject port (in this case, the learning table 31).

When a packet having the same source MAC address and destination MAC address as the subject packet has been received at a port other than the subject port before the counted number reaches the predetermined value (Yes in step S16), the transfer control unit 26 determines that a network failure has occurred. Accordingly, in step S20, the counted packets having a common source MAC address and destination MAC address with the subject packet are discarded from the buffer unit 23.

In step S21, the transfer control unit 26 causes the BPDU sending unit 27 to generate a BPDU packet, and send the BPDU packet out from the subject port that has received the subject packet (in this example, port P1), so as to prompt reconstruction of the network.

Accordingly, flooding is prevented from being performed if a source MAC address of a received packet is registered in a learning table corresponding to any of the ports. Thus, flooding operations can be reduced, and hence reduction of the available bandwidth of an operating network can be prevented. Furthermore, when a network failure occurs, a BPDU packet is sent out to reconstruct the network, thereby maintaining reliability of the network.

### SECOND EMBODIMENT

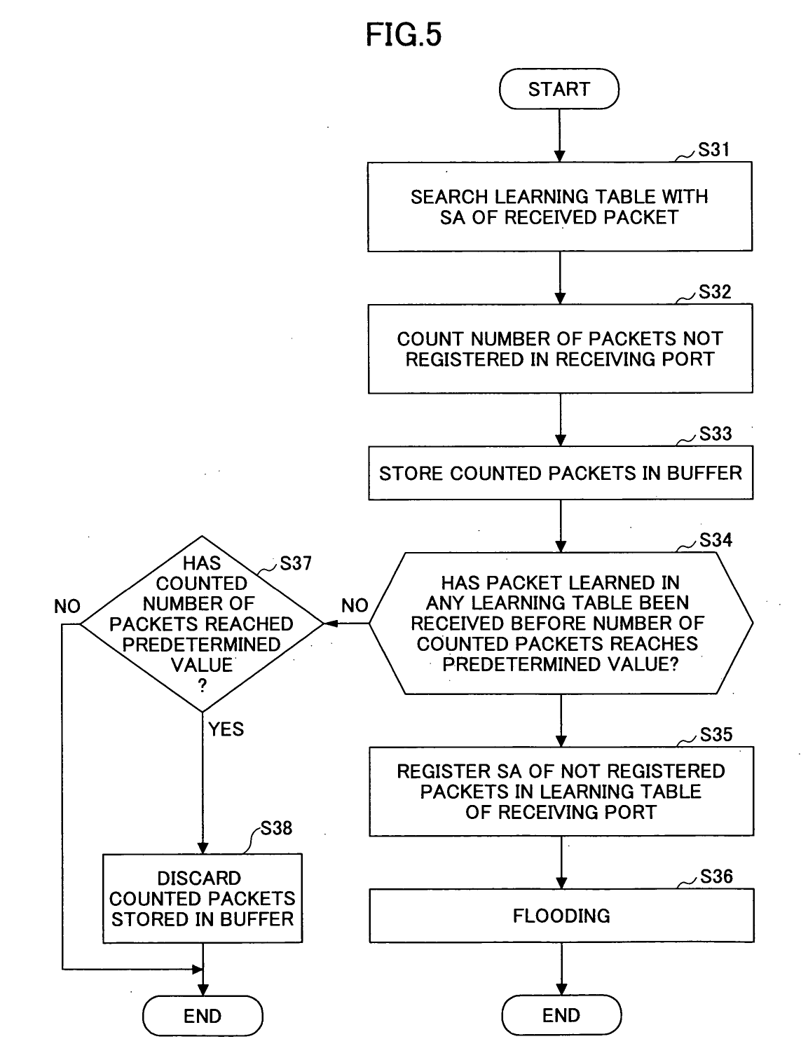

FIG. 5 is a flowchart according to a second embodiment of the present invention. In step S31 in FIG. 5, the learning search unit 21 searches a learning table corresponding to the port (for example, the port P1; hereinafter, “subject port”) that received a packet (hereinafter, “subject packet”), using the source MAC address of the subject packet. The search results are supplied to the transfer control unit 26.

When the source MAC address of the subject packet is not registered in the learning table corresponding to the subject port, in step S32, the transfer control unit 26 causes the counter unit 22 to count the number of packets received at the subject port, but whose source MAC addresses are not registered in the learning table corresponding to the subject port (number of not registered packets). In step S33, the transfer control unit 26 stores the counted packets in the buffer unit 23.

In step S34, the transfer control unit 26 determines whether a packet that is registered in any of the learning tables 31 through 34 (hereinafter, “registered packet”) has been received at any of the ports P1 through P4, before the number of packets counted by the counter unit 22 (number of not registered packets) reaches a predetermined value (for example, 100). The transfer control unit 26 makes this determination based on whether time stamps associated with source MAC addresses and destination MAC addresses in the learning tables 31 through 34 have been updated.

When a registered packet has been received (Yes in step S34), the transfer control unit 26 determines that there is no invalid packet attack. Accordingly, in step S35, the transfer control unit 26 registers source MAC addresses of the packets that are not registered in the learning table corresponding to the subject port that have received these packets (in this example, the learning table 31), and performs flooding in step S36. Specifically, the transfer control unit 26 causes the copy unit 24 to create copies of the packets corresponding to the number of other output ports (for three ports), and outputs the copies from the other ports (P2 through P4) via the switch unit 25.

On the other hand, when a registered packet has not been received (No in step S34), the transfer control unit 26 determines that an invalid packet attack has been launched by continuously changing the source MAC address of the packets. Accordingly, in step S37, the transfer control unit 26 determines whether the number of packets counted by the counter unit 22 (number of not registered packets) has reached the predetermined value. When the counted number has reached the predetermined value (Yes in step S37), in step S38, the packets that are not registered, whose source MAC addresses are not registered, are discarded from the buffer unit 23.

Thus, all packets generated by a MAC scan attack can be discarded, thereby reliably protecting the network from MAC scan attacks.

The transmission apparatus 20 can perform either or both of the operations described in the first embodiment and the second embodiment. If both operations are to be performed, steps S31 through S38 of the second embodiment are performed in step S13 of the first embodiment.

According to one embodiment of the present invention, it is possible to reduce flooding operations, and hence prevent reduction of the available bandwidth of an operating network, and to maintain reliability of the network.

Further, according to one embodiment of the present invention, it is possible to reliably protect the network from MAC scan attacks.

The present invention is not limited to the specifically disclosed embodiment, and variations and modifications may be made without departing from the scope of the present invention.

The present application is based on Japanese Priority Patent Application No. 2006-087429, filed on Mar. 28, 2006, the entire contents of which are hereby incorporated by reference.

What is claimed is:

1. A transmission apparatus for determining a port from which a received packet is to be sent out among a plurality of ports by searching learning tables each corresponding to one of the ports, comprising:
a searching unit configured to search the learning tables corresponding to the ports, other than a first port that has received a first packet, using a source address and a destination address of the first packet whose source address and destination address are not registered in a first learning table corresponding to the first port; and
a transferring unit configured to transfer contents of a second learning table, corresponding to a second port, to the first learning table, in response to the searching unit finding that the source address and the destination address of the first packet are registered in the second learning table; wherein
a port from which the first packet is to be sent out is determined based on the contents transferred to the first learning table.

2. The transmission apparatus according to claim 1, further comprising:
a first counting unit configured to count a number of the packets received by the first port whose source addresses and destination addresses are the same as the first packet and found by the searching unit to be not registered in the first learning table but registered in the learning tables corresponding to other ports, in response to the searching unit finding that the source address and the destination address of the first packet are registered in a learning table corresponding to another port;
a buffer unit configured to store the packets counted by the first counting unit; and
a first discarding unit configured to discard from the buffer unit the packets whose source addresses and destination addresses are not registered in the first learning table but is registered in the learning tables corresponding to other ports, in response to another port receiving another packet having the same source address and destination address as the first packet before the counted number reaches a predetermined limit.

3. The transmission apparatus according to claim 2, further comprising:
a sending unit configured to send out a controlling packet for reconstructing a network, in response to another of the ports receiving another packet having the same source address and destination address as the packet before the counted number reaches the predetermined limit.

4. A transmission apparatus for determining a port from which a received packet is to be sent out among a plurality of ports by searching learning tables each corresponding to one of the ports, comprising:
a searching unit configured to search, in response to receipt of a packet by any given port, a learning table corresponding to the given port using a source address of the packet received by the given port;
a counting unit configured to count a number of non-registered packets whose source addresses are found by the searching unit to be not registered in the corresponding learning table;
a buffer unit configured to store the packets counted by the counting unit; and
a discarding unit configured to discard from the buffer unit the non-registered packets in response to the counted number reaching a predetermined limit without receiving, during the counting of the number, any packet registered in any one of the learning tables.

5. The transmission apparatus according to claim 2, further comprising:
a second counting unit configured to count a number of non-registered packets whose source addresses are found by the searching unit to be not registered in the corresponding learning table; and
a second discarding unit configured to discard from the buffer unit the non-registered packets in response to the counted number reaching a predetermined limit without receiving, during the counting of the number, any packet registered in any one of the learning tables.

6. The transmission apparatus according to claim 1, further comprising:
a first flooding unit configured to perform flooding when the source address of the first packet is not registered in any port.

7. The transmission apparatus according to claim 5, further comprising:
a second flooding unit configured to perform flooding in response to receiving a packet registered in any of the learning tables before the counted number reaches the predetermined limit.
